(19) United States
(12) Patent Application Publication
(10) Pub. No.: US 2024/0327996 A1
(43) Pub. Date: Oct. 3, 2024

(54) System and Method for Generating Hydrogen

(71) Applicant: Erthos IP LLC, Tempe, AZ (US)

(72) Inventor: James S. Tyler, Tempe, AZ (US)

(73) Assignee: Erthos IP LLC, Tempe, AZ (US)

(21) Appl. No.: 18/194,136

(22) Filed: Mar. 31, 2023

(51) Int. Cl. C25B 1/044; C25B 15/08; F17C 13/00

(52) U.S. Cl. CPC C25B 1/044; C25B 15/083; F17C 13/002; F17C 2221/011; F17C 2221/012; F17C 2223/0123; F17C 2223/036; F17C 2225/0123; F17C 2270/0168; F17C 2270/05

(57) ABSTRACT

In some implementations, a method may include generating, by a solar power generator, DC power, wherein the solar power generator may have a flat-on-ground configuration. The method may include receiving, by one or more electrolyzers, the DC power. The method may include generating, by the one or more electrolyzers and via an electrolysis process, oxyhydrogen (HHO) using the DC power.

### BACKGROUND

Solar power is the conversion of energy from sunlight into electricity, which may be achieved using photovoltaic (PV) cells that convert light into an electric current use the photovoltaic effect. Electrolysis is a technique that uses direct electric current (DC) to drive an otherwise non-spontaneous reaction.

### SUMMARY

According to implementations described herein, a system for generating hydrogen may include a solar power generator configured to generate DC power. The system may include a plurality of electrolyzers configured to receive the DC power from the solar power generator, wherein a particular electrolyzer, of the plurality of electrolyzers, is configured to generate oxyhydrogen (HHO) based on electrolysis of water using the DC power. The system may include a gas separator configured to separate hydrogen gas and oxygen gas from the HHO. The system may include a gas compressor configured to compress the hydrogen gas. The system may include one or more transporters configured to transport the hydrogen gas or the HHO to be consumed at a location external to a campus site on which the solar power generator, the plurality of electrolyzers, the gas separator, and the gas compressor are located.

According to some implementations, a system for generating hydrogen may include a solar power generator configured to generate DC power. The system may include one or more electrolyzers configured to receive the DC power from the solar power generator, wherein a particular electrolyzer, of the one or more electrolyzers, is configured to generate oxyhydrogen (HHO) based on electrolysis of water using the DC power. The system may include a boiler configured to receive the HHO from the plurality of electrolyzers, wherein the boiler may be configured to combust the HHO go generate steam. The system may include a distribution system by which the steam may be collected and distributed for use in an industrial process.

According to some implementations, a method for generating hydrogen may include generating, by a solar power generator, DC power, wherein the solar power generator has a flat-on-ground configuration. The method may include receiving, by one or more electrolyzers, the DC power. The method may include generating, by the one or more electrolyzers and via an electrolysis process, oxyhydrogen (HHO) using the DC power.

### BRIEF DESCRIPTION OF THE DRAWINGS

FIG. 1 is a diagram of a prior art electrolysis hydrogen manufacturing system.

FIG. 2 is a diagram of an exemplary system for generating hydrogen according to embodiments of the present disclosure.

FIG. 3 is a diagram of an exemplary system for generating hydrogen according to embodiments of the present disclosure.

FIG. 4 is a diagram of an exemplary system for generating hydrogen according to embodiments of the present disclosure.

FIG. 5 is a flow diagram of an exemplary process associated with generating hydrogen.

### DETAILED DESCRIPTION

Electrolysis has shown to be a promising way to create hydrogen in a carbon free or near carbon free manner from renewable sources, such as water, potassium hydroxide (KOH) and sodium hydroxide (NaOH) solutions, and other electrolytes. Electrolysis is a process that uses electricity to split water into hydrogen and oxygen in a reaction chamber known as an electrolyzer. Electrolyzers can range in size from relatively small “table-top” size devices, to large, industrial scale “factory” sized devices. The reaction chambers or “cells” are often connected together in series to form “stacks” to increase the hydrogen and oxygen output.

A variety of electrolyzers are known in the art, generally consisting of at least one anode and at least one cathode and submerged in water or another electrolyte solution. An electric current passing through the anode and cathode causes the water to split into oxygen (anode side) and hydrogen (cathode side), either or both of which can be collected and used for a variety of purposes, including downstream power generation.

For example, the hydrogen can be used as fuel for fuel-cell electric vehicles such as automobiles, buses and other vehicles. The hydrogen can also be used to power factories, and in place of or to supplement other heating and power-generating gases such as natural gas. The hydrogen can also be used as in the production of other chemicals and compositions, such as methanol, fertilizers and other fuels.

While hydrogen is often manufactured near where it is intended to be used, it is possible to distribute hydrogen through a variety of known methods, for example, by compressing the hydrogen gas in high-pressure containers and shipping the hydrogen by trucks, train, or other transport vehicles. Alternatively, the hydrogen may be transported via other means such as gas or liquid fuel pipelines.

However, though electrolysis has shown to be a promising way to create environmentally friendly hydrogen gas, there remain challenges related to production, including the manner of powering the electrolysis systems in an efficient and environmentally friendly manner and minimizing the number of steps required to generate and transport the hydrogen.

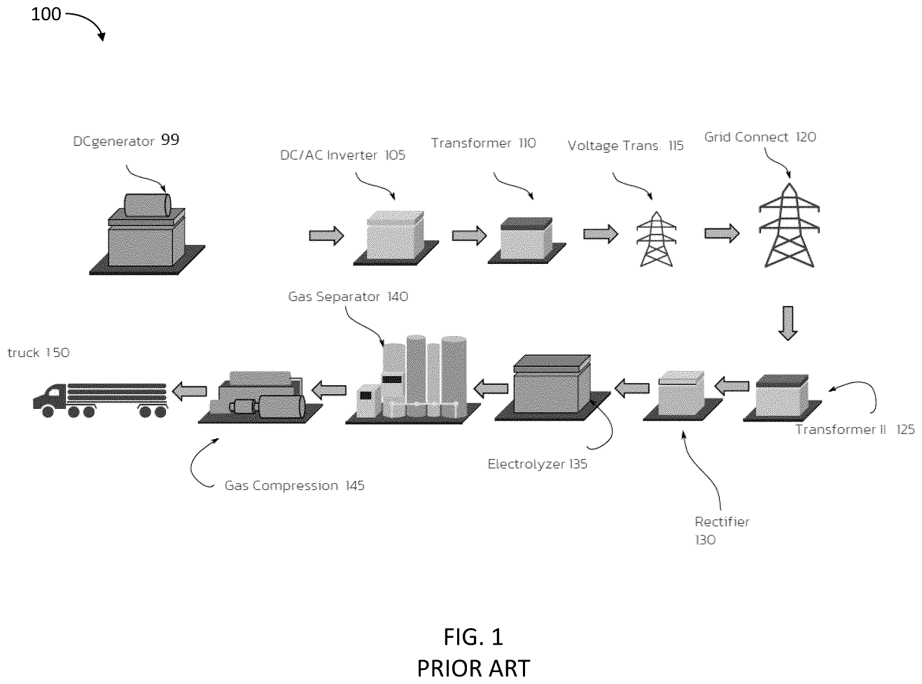

For example, FIG. 1 is a typical prior art electrolysis hydrogen manufacturing process illustrating a complex system having an electrolyzer power generator such as a DC generator 99, a DC/AC inverter 105, a transformer 110, voltage transfer components 115 and/or grid connect components 120 which provide power to a second transformer 125, a rectifier 130, an electrolyzer 135, a gas separator 140, a gas compressor 145, and a transport vehicle 150.

These components and steps require high capital investments, may suffer from inefficiencies and losses at or between each step, and if any one or more of these components fail, the system loses operational capacity and capability. The resulting cost for manufacturing hydrogen in systems such as that illustrated in FIG. 1 has been demonstrated to cost anywhere from US $3.30/kg and upward.

Accordingly, improved and more efficient systems and methods for hydrogen manufacture, processing, and shipping are desirable.

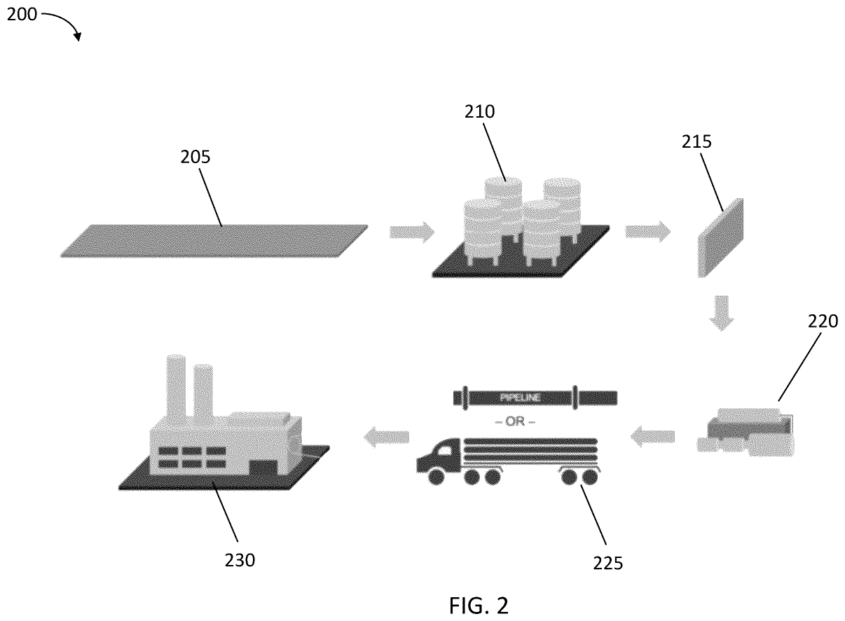

FIGS. 2-4 are diagrams illustrating of example systems 200, 300, and 400 that utilize solar-generated power together with an electrolysis process to generate hydrogen.

As shown in FIG. 2, system 200 may include a DC power source, e.g., solar power generator 205, configured to generate DC power. The solar power generator 205 may have one or more photovoltaic (PV) arrays and/or may have a flat-on-ground configuration (e.g., lay flat on the ground in contrast to a solar tracker system that follows the sun). For example, the solar power generator 205 may be a solar PV array as described in U.S. patent application Ser. No. 16/682,503, the contents of which are incorporated by reference herein in their entirety. The solar power generator may be connected in series or in parallel.

System 200 may include one or more electrolyzers 220. The electrolyzer(s) 220 may be configured to receive the DC power from the solar power generator 205 and to generate oxyhydrogen (HHO) using the DC power and based on an electrolysis process. For example, the electrolyzer(s) 220 may be those described in U.S. patent application Ser. No. 17/820,222, the contents of which are incorporated by reference herein in their entirety.

System 200 may include a gas separator 215 and a gas compressor 220. The gas separator 215 may be configured to separate hydrogen gas and oxygen gas from the HHO. The gas compressor 220 may be configured to compress the hydrogen gas and/or the oxygen gas. The separation and compression of the hydrogen gas and/or the oxygen gas may be done using known separation and compression techniques, such as pressure swing adsorption (PSA) or gravitational separation.

System 200 may include one or more transporters 225 configured to transport the hydrogen gas and/or the HHO (e.g., to a facility or location 230 remote from a site at which the generation of HHO, separation and compression occur). In some implementations, a transporter 225 may be a vehicle (e.g., a truck) with a storage tank in which the hydrogen gas or the HHO may be transferred and stored during transport. The storage tank may be rated at a specific pressure rating (e.g., 10,000 psi) to store and transport a set amount of hydrogen gas or HHO. Additionally, or alternatively, the transport 225 may be a pipeline or a series of pipelines to the remote location 230 from the site.

In some implementations, the compressed hydrogen gas may have a purity that satisfies a first threshold value. For example, the first threshold value may be 99.999%, such as when hydrogen gas is being transported. In other implementations, the compressed hydrogen gas and the compressed oxygen gas may have purities that satisfy a second threshold value, which may be the same as or may be different from the first threshold value. For example, the second threshold value may be 99.0%, such as when the HHO is being transported.

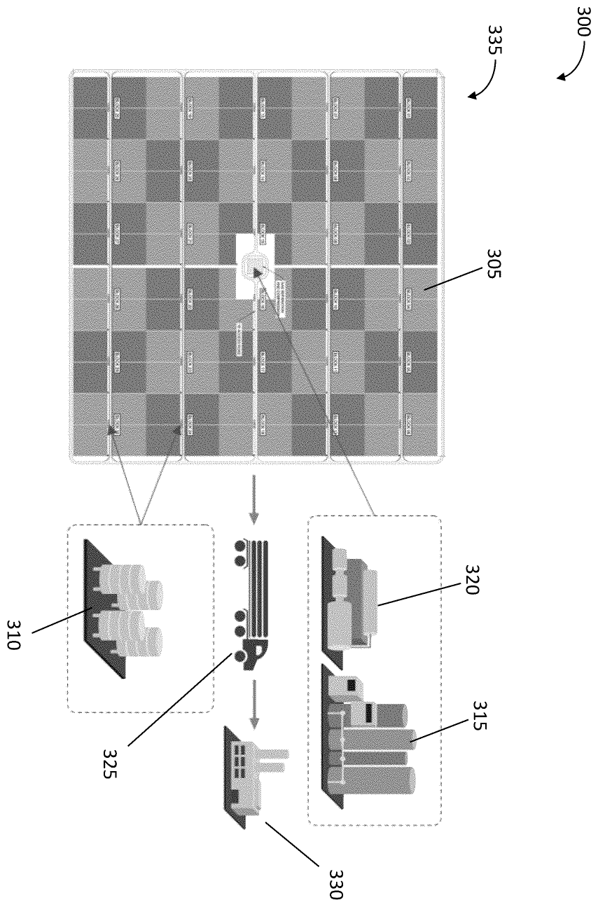

As shown in FIG. 3, system 300 may include similar components as system 200. For example, system 300 may include a solar power generator 305, which may be a solar PV array and/or have a flat-on-ground configuration, as described in U.S. patent application Ser. No. 16/682,503, to generate DC power. System 300 may include multiple electrolyzers 310, such as the electrolyzer described in U.S. patent application Ser. No. 17/820,222, to receive and use the DC power to generate HHO via an electrolysis process. System 300 may include a gas separator 315 to separate hydrogen gas and oxygen gas from the HHO, and a gas compressor 320 to compress the hydrogen gas and/or the oxygen gas. System 300 may include one or more transporters 325 (e.g., a vehicle) to transport the hydrogen gas and/or the HHO to a remote facility 320.

In some implementations, system 300 may include a campus site 355 having a large area to house a number of solar arrays to generate a large magnitude of DC power (e.g., at least 100 MW). For example, a campus site 355 having an area of approximately 1.5 square miles could produce 1 GW of DC power. In such an implementation, the electrolyzers 310 may be distributed throughout the campus site 355 and receive DC power from set PV arrays of the solar power generator 305. The HHO generated from the electrolyzers 310 may be collected and routed (e.g., via a piping system) to the gas separator 315 and the gas compressor 320 at a central location of the campus site 355. From the central location, the transporter(s) 325 may collect the hydrogen gas or the HHO to transport to the remote facility 330.

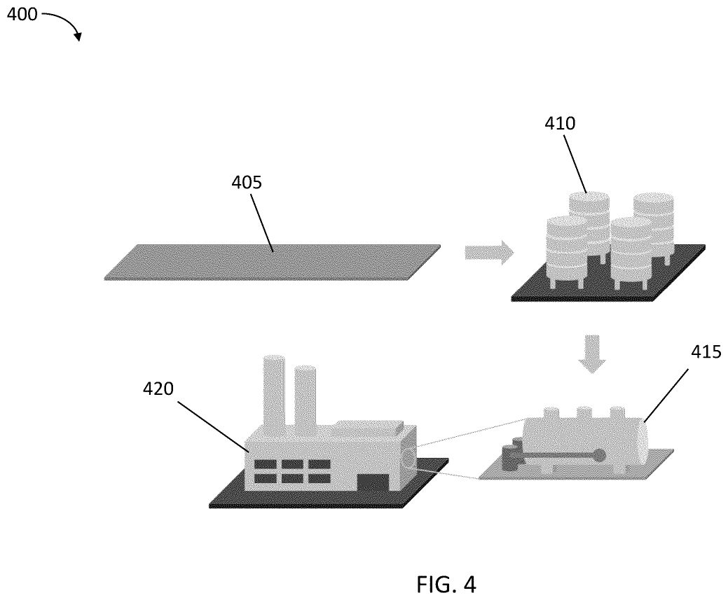

As shown in FIG. 4, system 400 may include similar components as systems 200 and 300. For example, system 400 may include a solar power generator 305, which may be a solar PV array and/or have a flat-on-ground configuration, as described in U.S. patent application Ser. No. 16/682,503, to generate DC power. System 400 may include one or more electrolyzers 310, such as the electrolyzer described in U.S. patent application Ser. No. 17/820,222, to receive and use the DC power to generate HHO via an electrolysis process.

System 400 may include a boiler 415 configured to combust the HHO to generate steam for use in an industrial process, such as at an industrial facility 420. The boiler 415 may be similar to a HHO boiler described in U.S. patent application Ser. No. 18/193,057, the contents of which are incorporated by reference herein in their entirety. The boiler 415 may be configured to receive the HHO from the one or more electrolyzers 420. Additionally, or alternatively, system 400 may include a gas separator and a gas compressor (not shown), for example, within the industrial facility 420. The boiler 415 may receive and combine the hydrogen gas and the oxygen gas, and combust the combined hydrogen gas and oxygen gas.

Systems 200, 300, and 400 described above utilize solar-generated DC power with an electrolysis process to be able to generate hydrogen. In contrast to system 100 shown in FIG. 1, the electrolyzer(s) 210, 310, and 410 are able to receive the DC power from the solar power generators 205, 305, and 405, thereby eliminating the need for such additional equipment as the DC/AC inverter 105, the transformer 110, the voltage transfer components 115, the grid connect 120 the second transformer 125, and the rectifier 130. Accordingly, because these components and steps require high capital investments, their elimination likewise removes potential inefficiencies and losses that occur through inherent limitations and/or failure of any one of these components. Thus, the resulting cost per kilogram of hydrogen for manufacturing hydrogen in the improved systems 200, 300 and 400 may result in a cost per kilogram of hydrogen of US $1.30/kg or less.

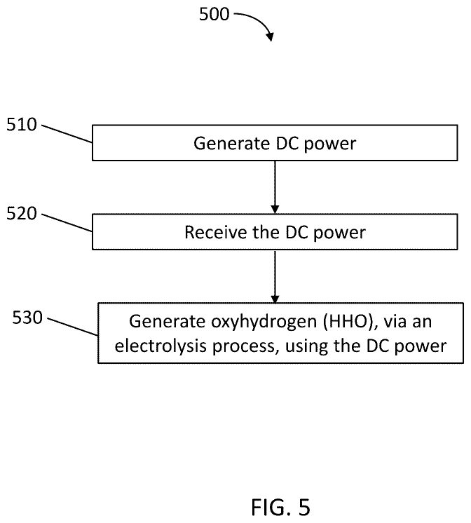

FIG. 5 is a flowchart of an example process 500 associated with generating hydrogen performed by a system (e.g., system 100, 200, 300, or 400). In some implementations, one or more process blocks of FIG. 5 may be performed by one or more components of system 200, 300, or 400.

As shown in FIG. 5, process 500 may include generating DC power (block 510). For example, solar power generator 205, 305, or 405 may generate DC power. In some implementations, solar power generator 205, 305, or 405 may have a flat-on-ground configuration.

As shown in FIG. 5, process 500 may include receiving the DC power (block 520). For example, one or more electrolyzers 210, 310, or 410 may receive the DC power (e.g., from solar power generator 205, 305, or 405).

As shown in FIG. 5, process 500 may include generating, via an electrolysis process, oxyhydrogen (HHO) using the DC power. For example, the one or more electrolyzers 210, 310, or 410 may generate HHO via an electrolysis process using the DC power.

In some implementations, process 500 may include transmitting the HHO to a gas separator (e.g., gas separator, separating, by the gas separator, hydrogen gas and oxygen gas from the HHO, and compressing, by a gas compressor, the hydrogen gas. In some implementations, the one or more electrolyzers may include multiple electrolyzers, wherein the solar power generator, the electrolyzers, the gas separator, and the gas separator are located within a campus site. In some implementations, the compressed hydrogen gas may have a minimum purity of 99.999%. In some implementations, process 500 may include transporting the hydrogen gas to a location external to the campus site.

In some implementations, process 500 may include compressing the oxygen gas. The hydrogen gas and/or the oxygen gas may have a minimum purity of 99.0%. In some implementations, process 500 may include transporting the hydrogen gas and the oxygen gas to a location external to the campus site.

In some implementations, process 500 may include receiving, by a boiler (e.g., an HHO boiler), the HHO, and combusting, by the boiler, the HHO to generate steam.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description but is not intended to be exhaustive or to limit the implementations to the precise forms disclosed. Modifications and variations may be made in light of the above disclosure or may be acquired from practice of the implementations described herein.

As used herein, the terms “substantially” and “approximately” mean “within reasonable tolerances of manufacturing and measurement.” As used herein, “satisfying a threshold” may, depending on the context, refer to a value being greater than the threshold, greater than or equal to the threshold, less than the threshold, less than or equal to the threshold, equal to the threshold, not equal to the threshold, or the like. All ranges described herein are inclusive of numbers at the ends of those ranges, unless specifically indicated otherwise.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system comprising:
a solar power generator configured to generate DC power;
a plurality of electrolyzers configured to receive the DC power from the solar power generator,
wherein a particular electrolyzer, of the plurality of electrolyzers, is configured to generate oxyhydrogen (HHO) based on electrolysis of water using the DC power;
a gas separator configured to separate hydrogen gas and oxygen gas from the HHO;
a gas compressor configured to compress the hydrogen gas; and
one or more transporters configured to transport the hydrogen gas or the HHO to be consumed at a location external to a campus site on which the solar power generator, the plurality of electrolyzers, the gas separator, and the gas compressor are located.

2. The system of claim 1, wherein the solar power generator has a flat-on-ground configuration.

3. The system of claim 1, wherein the DC power is at least 100 MW.

4. The system of claim 1, wherein the transporter is a vehicle.

5. The system of claim 4, wherein the vehicle includes a storage tank rated for 10,000 psi.

6. The system of claim 1, wherein the transporter includes a pipeline.

7. The system of claim 1, wherein:
the plurality of electrolyzers are distributed throughout the campus site, and
the gas separator and the gas compressor are centrally located in the campus site.

8. A system comprising:
a solar power generator configured to generate DC power;
one or more electrolyzers configured to receive the DC power from the solar power generator,
wherein a particular electrolyzer, of the one or more electrolyzers, is configured to generate oxyhydrogen (HHO) based on electrolysis of water using the DC power; and
a boiler configured to combust the HHO to generate steam for use in an industrial process.

9. The system of claim 8, wherein the solar power generator has a flat-on-ground configuration.

10. The system of claim 8, wherein the boiler is configured to receive the HHO from the one or more electrolyzers.

11. The system of claim 8, further comprising:
a gas separator configured to separate hydrogen gas and oxygen gas from the HHO; and
a gas compressor configured to compress at least one of the hydrogen gas or the oxygen gas.

12. The system of claim 11, wherein the boiler is configured to:
receive the hydrogen gas and the oxygen gas;
combine the hydrogen gas and the oxygen gas; and
combust the combined hydrogen gas and oxygen gas.

13. A method comprising:
generating, by a solar power generator, DC power,
wherein the solar power generator has a flat-on-ground configuration;
receiving, by one or more electrolyzers, the DC power; and
generating, by the one or more electrolyzers and via an electrolysis process, oxyhydrogen (HHO) using the DC power.

14. The method of claim 13, further comprising:
transmitting the HHO to a gas separator;
separating, by the gas separator, hydrogen gas and oxygen gas from the HHO; and
compressing, by a gas compressor, the hydrogen gas,
wherein the one or more electrolyzers include a plurality of electrolyzers, and
wherein the solar power generator, the plurality of electrolyzers, the gas separator, and the gas compressor are located within a campus site.

15. The method of claim 14, wherein the compressed hydrogen gas has a purity that satisfies a threshold value.

16. The method of claim 15, wherein the threshold value is 99.999%.

17. The method of claim 15, further comprising:
transporting the compressed hydrogen gas to a location external to the campus site.

18. The method of claim 14, further comprising:
compressing the oxygen gas,
wherein the compressed hydrogen gas and the compressed oxygen gas have purities that satisfy a threshold value of 99.0%.

19. The method of claim 18, further comprising:
transporting the hydrogen gas and the oxygen gas to a location external to the campus site.

20. The method of claim 13, further comprising:
receiving, by a boiler, the HHO; and
combusting, by the boiler, the HHO to generate steam.
